(19) United States
(12) Patent Application Publication
(10) Pub. No.: US 2013/0098595 A1
(43) Pub. Date: Apr. 25, 2013

(54) TEMPERATURE CONTROL DEVICE AND METHOD FOR GENERATING A TEMPERATURE-CONTROLLED AIR FLOW

(71) Applicant: Behr GmbH & Co. KG, Stuttgart (DE)

(72) Inventor: Matthias SCHALL, Ostfildern-Ruit (DE)

(73) Assignee: Behr GmbH & Co. KG, Stuttgart (DE)

(21) Appl. No.: 13/691,267

(22) Filed: Nov. 30, 2012

Related U.S. Application Data
(63) Continuation of application No. PCT/EP2011/058189, filed on May 19, 2011.

(30) Foreign Application Priority Data
May 31, 2010 (DE) DE102010029495.0

(51) Int. Cl. B60H 1/00; G05D 23/13

(52) U.S. Cl. CPC B60H 1/0005; G05D 23/138
USPC 165/202; 236/12.15

(57) ABSTRACT

A temperature control device for a vehicle is provided that includes a first air duct for guiding a first portion of an air flow and a second air duct for guiding a second portion of an air flow. A cooling device is disposed in the first air duct, in order to cool the first portion of the air flow. A mixer device is provided for mixing the first air flow from the first air duct with the second portion of the air flow from the second air duct in order to generate a temperature controlled air flow.

This nonprovisional application is a continuation of International Application No. PCT/EP2011/058189, which was filed on May 19, 2011, and which claims priority to German Patent Application No. DE 10 2010 029 495.0, which was filed in Germany on May 31, 2010, and which are both herein incorporated by reference.

### BACKGROUND OF THE INVENTION

1. Field of the Invention

The present invention relates to a temperature control device for a vehicle, to a control unit for a temperature control device, and to a method for generating a temperature-controlled air flow for a vehicle.

2. Description of the Background Art

In a cooling mode, setpoint ventilation air temperatures above about 10° C. can no longer be generated in all cases with conventional climate control devices or climate control systems directly at an evaporator. The reason for this can be, for example, that the rotational speed at the compressor would have to fall below the minimal allowable speed or that the delivery stroke, necessary for this, at the compressor is smaller than the realizable minimal stroke of the compressor.

In certain types of evaporators, material-related odor occurs at evaporator temperatures above 10° C. Here then the air temperature downstream of the evaporator is limited to a maximum of 8-10° C. by means of control technology.

If higher temperatures are necessary, these need to be generated by the supplying of additional power in the heater (reheat mode). This power must be provided from a power source, for example, the fuel or battery of the vehicle. This causes an increase in power consumption, as a result of which the (energy) efficiency of the climate control device or climate control system declines.

With respect to the interior comfort, known climate control devices also have disadvantages. Depending on the evaporator temperature, in the cooling mode the air is greatly dehumidified in the evaporator. The evaporator temperature in fact corresponds approximately to the dew point temperature of the air downstream of the evaporator. This effect is desirable, on the one hand, to reduce the humidity in the interior and thereby to reduce the risk of window condensation, but, on the other, the moisture within the cabin can drop to values which are outside the comfort range. For example, at a relative humidity of less than 30% there is the risk of the drying of mucous membranes.

### SUMMARY OF THE INVENTION

It is therefore an object of the present invention to provide an improved temperature control device for a vehicle, an improved control unit for a temperature control device, and an improved method for generating a temperature-controlled air flow for a vehicle.

The present invention is based on the realization that a temperature-controlled air flow can be generated with a lower energy input and higher quality, when not the entire but only part of the air flow used to generate the temperature-controlled air flow is cooled. The part of the original air flow that is not cooled can be combined in a suitable proportion and in a suitable manner with the cooled air flow to generate the temperature-controlled air flow. A temperature of the temperature-controlled air flow can be regulated by regulating the proportion between the cooled and uncooled air flow. In particular, the temperature of the temperature-controlled air flow can be increased beyond a temperature of the cooled air flow, without heat energy having to be used for this purpose. Likewise, the air humidity of the temperature-controlled air flow can be increased. Thus, for example, no additional humidifier in the interior of the vehicle is necessary for the moisture control.

According to an embodiment, a method for the energy-efficient control of the temperature downstream of an evaporator of a climate control unit or a method for the energy-efficient control of the air humidity in the vehicle interior is created by means of a bypass at the evaporator connected to the associated regulating system and sensors. This enables an increase in efficiency and an increase in comfort, for example, in vehicles with a climate control unit.

Since, at least in motor vehicles, a climate control unit is standard equipment or has a very high penetration rate, the demand for climate control increases. Two main points here are the energy efficiency, with the catchword of CO₂ reduction, and interior comfort.

Advantageously, the approach of the invention enables improvement of the climate control device or climate control system in order to generate air temperatures above 10° C. downstream of the evaporator without additional heating. Furthermore, there is the possibility of influencing the air humidity in the cabin, at least within certain limits.

In an embodiment, the present invention provides a temperature control device for a vehicle, having the following features: a first air duct for guiding a first portion of an air flow; a cooling device, which is disposed in the first air duct and is designed to cool the first portion of the air flow; a second air duct for guiding a second portion of the air flow; and a mixing device which is designed to mix the first air flow from the first air duct with the second portion of the air flow from the second air duct in order to generate a temperature-controlled air flow.

The temperature control device can be a climate control unit or a climate control device. The temperature control device can be disposed in a motor vehicle. The air flow used by the temperature control device to generate the temperature-controlled air flow can be drawn from an environment of the temperature control device. For example, the air flow can be drawn from a vehicle environment or a vehicle interior. Thus, the air flow and thereby the first portion of the air flow, which is supplied to the first air duct, and the second portion of the air flow, which is supplied to the second air duct, can have a temperature and humidity corresponding to an ambient air or interior air of the vehicle. The air flow can be supplied to the temperature control device via a supply opening and then divided into the first and second portion. The air ducts can be made as lines or channels. The entire first portion of the air flow can be passed through the cooling device. In the activated state, the cooling device is designed to lower a temperature of the first portion of the air flow and to output it as a cooled air flow. The cooling device can be configured as an evaporator. The mixing device can be made as a chamber into which the air duct outlets open. The temperature-controlled air flow generated by the temperature control device can be guided into an interior of the vehicle in order to control the interior temperature of the vehicle.

The second air duct can be designed to guide the second portion of the air flow past the cooling device to the mixing device. Thus, the second air duct can lead to a bypassing of the cooling device, so that the second portion of the air flow is not guided through the cooling device.

The mixing device can be configured as an air channel section, which has a supply opening for supplying the first portion of the air flow, a supply opening for supplying the second portion of the air flow, and a discharge opening for discharging the temperature-controlled air flow.

Further, the temperature control device may have a heating device, which is disposed in the flow direction of the first portion of the air flow downstream of the cooling device. The heating device can be designed to heat at least one part of the first portion of the air flow. The second portion of the air flow can be mixed in the mixing device with the partially or totally heated first portion of the air flow. The heating device can be designed as an electrical heating element, as a heater through which a fluid flows, or as a heat pump system. According to an embodiment, the entire first portion of the air flow can be guided through the heating device and be output by the activated heating device as a heated air flow. A temperature of the heated air flow can be adjusted by regulating the heat output of the heating device, as is the case in prior-art water-side regulation. According to an alternative embodiment, the first portion of the air flow can be divided into two partial flows, one of which is heated by the heating device and the other bypasses the heating device, without being heated by the heating device. Next, both partial flows are again combined, for example, in the mixing device. By regulating the proportion between the two partial streams, a temperature of the recombined air flow can be regulated, as is the case in a prior-art air-side regulation.

According to another embodiment, the heating device can be designed further to heat at least one part of the second portion of the air flow. In this case, the second air duct can be joined to the first air duct in an area between the cooling device and the heating device. Next, the first portion of the air flow and the second portion of the air flow can be passed entirely through the heating device. Alternatively, the combined first and second portion of the air flow can be divided into two partial flows, one of which is heated by the heating device and the other bypasses the heating device, without being heated by the heating device. Next, both partial flows are again combined, for example, in the mixing device.

The temperature control device can have a housing, which has at least one inlet opening for letting in the air flow and at least one outlet opening for letting out the temperature-controlled air flow. The first air duct, the second air duct, and the mixing device can be disposed within the housing. Wall sections of the housing can make up partial sections of the air ducts. The air flow can be supplied to the inlet opening by means of a blower.

Further, the temperature control device may have a regulating device, which is designed to regulate a proportion of the portions of the air flows relative to one another and/or a cooling performance of the cooling device. The regulating device can also be designed to regulate the heat performance of the heating device and/or flow velocity of the air flow. The regulating device can be designed to regulate a temperature and/or moisture of the temperature-controlled air flow. The regulating device can have at least one adjustment device, for example, a valve, by which a division of the air flows in the individual air ducts can be adjusted.

To this end, the temperature control device may have a measuring device for measuring air flow temperature and/or humidity. The regulating device can be designed to regulate the proportion and/or the cooling performance depending on the temperature and/or humidity. The measuring device can be disposed within or outside the temperature control device.

The present invention provides further a control unit for a temperature control device. The control unit is designed to determine control information for controlling the temperature control device based on information on air flow temperature and information on temperature of the temperature-controlled air flow and/or an interior of the vehicle and a setpoint temperature of the temperature-controlled air flow and/or of the interior. In addition or alternatively, the control unit is designed to determine control information for controlling the temperature control device based on information on air flow humidity and information on the humidity of the temperature-controlled air flow and/or of an interior of the vehicle and a setpoint humidity of the temperature-controlled air flow and/or of the interior. The control information can be provided to a regulating device of the temperature control device. The setpoint temperature and the setpoint humidity can be predetermined by a vehicle occupant.

The present invention provides further a method for generating a temperature-controlled air flow for a vehicle, which comprises the following steps: guiding a first portion of an air flow by means of a first air duct; cooling of the first portion of the air flow; guiding a second portion of the air flow by means of a second air duct; and mixing of the first portion of the air flow from the first air duct with the second portion of the air flow from the second air duct in order to generate the temperature-controlled air flow. The method of the invention can be implemented in a climate control device or a climate control system.

Further scope of applicability of the present invention will become apparent from the detailed description given hereinafter. However, it should be understood that the detailed description and specific examples, while indicating preferred embodiments of the invention, are given by way of illustration only, since various changes and modifications within the spirit and scope of the invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus, are not limitive of the present invention, and wherein:

FIG. 1 shows an illustration of a climate control device;

FIG. 2 shows an illustration of a climate control system with a climate control device of the invention;

FIG. 3 shows an illustration of a climate control device of the invention; and

FIG. 4 shows an illustration of a control panel of the invention:

### DETAILED DESCRIPTION

In the following description of the preferred exemplary embodiments of the present invention, the same or similar reference characters are used for the elements with a similar action and shown in the different drawings, whereby a repeated description of these elements is omitted.

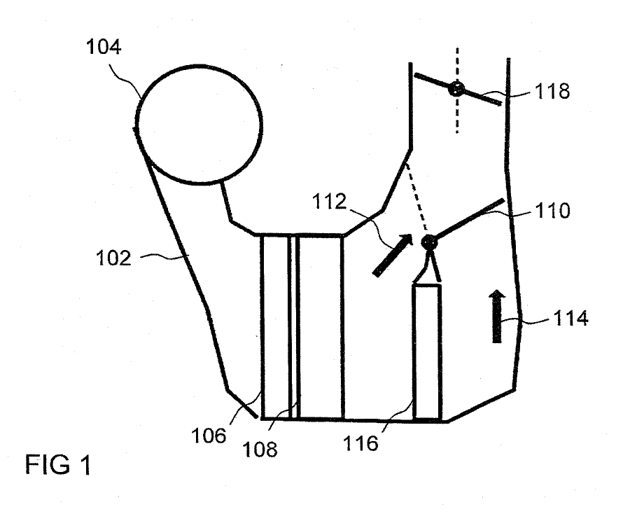

FIG. 1 shows a schematic illustration of a climate control device with air-side regulation. The climate control device has a housing 102 into which an air flow is blown in by a blower 104. The air flow is guided through a filter 106 and an evaporator 108. Next, the air flow branches and, depending on the position of a mixing valve 110, follows either a cold path 112 or a heat path 114, which passes over a heater 116, to one or more outlets of housing 102. The outlet/outlets is/are released or blocked by shut-off valve(s) 118.

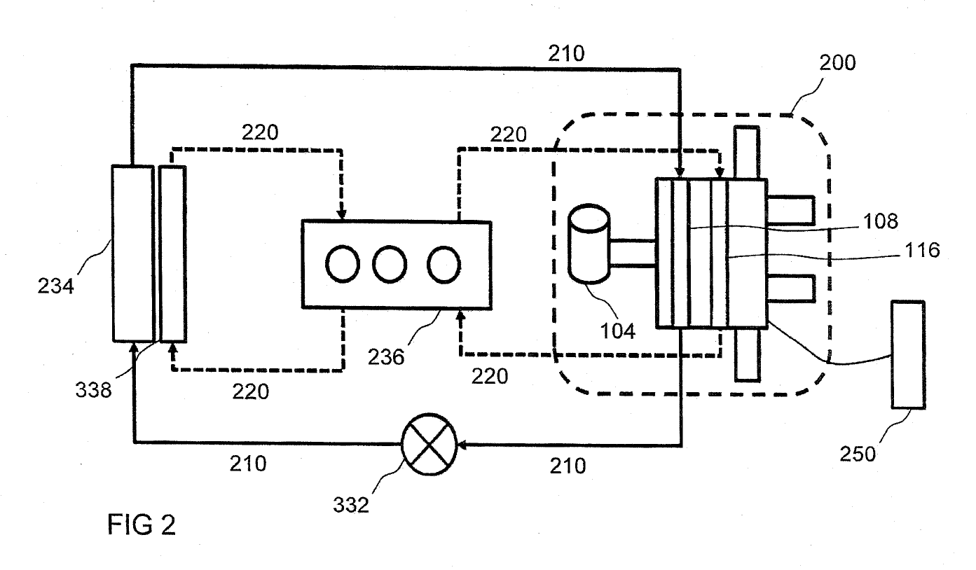

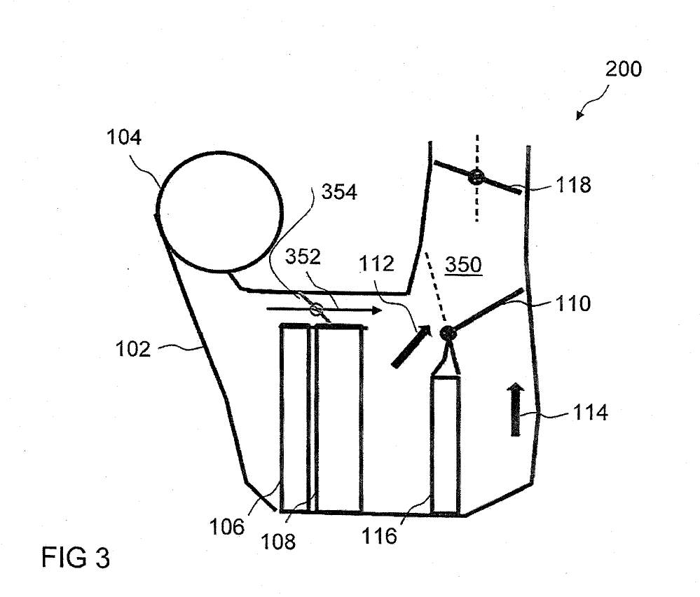

FIG. 2 shows a climate control system with a temperature control device or a climate control device 200 according to an exemplary embodiment of the present invention. The climate control system has a cooling circuit 210 and a heating circuit 220. Climate control device 200 is shown only schematically with blower 104, evaporator 108, and the heater. A possible exemplary embodiment of climate control device 200 is shown in FIG. 3.

Cooling circuit 210, proceeding from evaporator 108 via a compressor 332, runs to a condenser 234 and from condenser 234 back to evaporator 108.

Heating circuit 220 runs proceeding from an engine 236 to heater 116 and from heater 116 back to engine 236. Engine 236 can be provided for driving a vehicle. Further, heating circuit 220 runs proceeding from engine 236 to a cooler 338 and from cooler 338 back to engine 236.

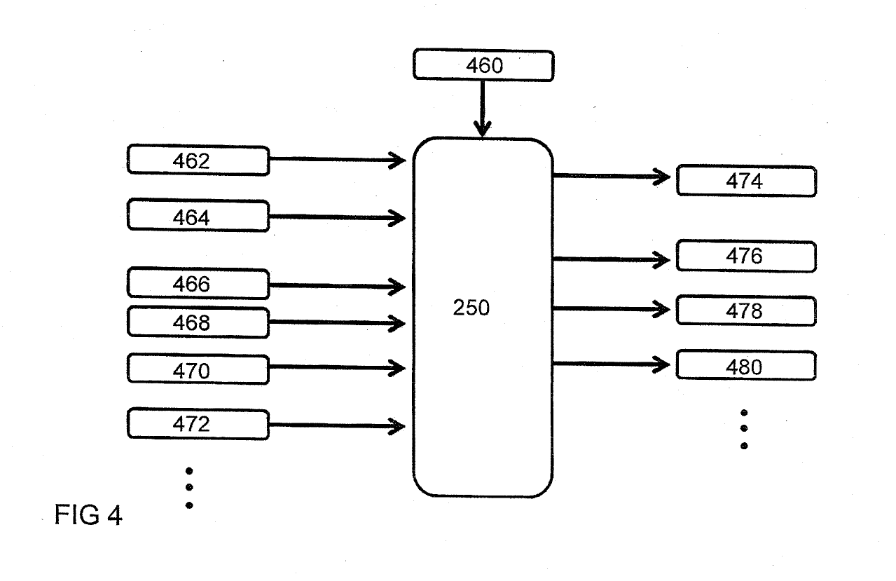

The climate control system further has a control panel 250 by which the climate control system can be operated. The climate control system can be disposed in a vehicle, so that it can be operated via control panel 250, for example, by a vehicle occupant. An exemplary embodiment of operating control panel 250 is shown in FIG. 4.

FIG. 3 shows a schematic illustration of a climate control device with air-side regulation, according to an exemplary embodiment of the present invention. The climate control device can be used in the climate control system shown in FIG. 2.

The climate control device has a housing 102 into which an air flow is blown in by a blower 104. A first part of the air flow is guided through a filter 106 and a cooling device, here an evaporator 108. Next, the first air flow branches and, depending on the position of a mixing valve 110, follows either a cold path 112 or a heat path 114, which passes over a heater 116, to a mixing chamber 350. Mixing chamber 350 is separated by a shut-off valve 118 from an outlet or a plurality of outlets of housing 102. The outlet is released or blocked via shut-off valve 118. A temperature-control air flow can flow out of the outlet. An air volume of the temperature-controlled air flow can correspond to a sum of the air volumes of the first and second portion of the air flow.

A second part of the air flow is routed via a bypass 352 past filter 106 and evaporator 108, so that the second part of the air flow bypasses both filter 106 and evaporator 108. The second part of the air flow is supplied to cold path 112. In cold path 112, the second part of the air flow can combine with a portion of the first air flow, which does not flow through heater 116. Further, a regulating element 354, which controls the amount of air flowing over the bypass, can be seen in FIG. 3 in bypass 352.

The portion of the air flow which is fed through heater 116 and the portion of the air flow which bypasses heater 116 can be adjusted via a position of mixing valve 110. The position can be adjusted via a control of the climate control device. In a first position, mixing valve 110 completely closes heat path 114. In this case, the complete first portion and the complete second portion of the air flow flow over cold path 112 into mixing chamber 350. In a second position, mixing valve 110 can completely close cold path 112. In this case, the complete first portion and the complete second portion of the air flow flow over heat path 114 into mixing chamber 350. In the intermediate positions of mixing valve 110, dependent on intermediate positions, portions of the first and second portion of the air flow can flow through cold path 112 and heat path 114.

The portion of the air flow which is passed through evaporator 108 and the portion of the air flow which is passed by evaporator 108, for example, via bypass 352 can be controlled via an additional valve 354 or another suitable regulating device.

According to other exemplary embodiments, the second part of the air flow, which is guided over a bypass, can be guided not in cold path 112 but in heat path 114, downstream of heater 116. The second part of the air flow can also be guided directly to mixing chamber 350. The second part of the air flow can also be branched off from the original air flow at a place different from that shown. For example, the first and second part of the air flow can also be fed through different openings into housing 102.

The climate control device shown in FIG. 3 can be used, for example, for the climate control system shown in FIG. 2, which has, apart from the climate control device, a heating circuit, a cooling circuit, or a heating system and a cooling system and an electronic control unit. The control unit can be made as a climate control panel, which processes different sensor signals and inputs and can control the climate control device or climate control system accordingly. For example, the ventilation air temperature, air volume, valve position, or compressor stroke can be controlled by means of the control unit. A possible embodiment of a control unit is shown in FIG. 4.

A climate control device, as shown in FIG. 3, can have a fresh air or circulating air intake, optionally a filter, blower 104, filter 106, evaporator 108, and heater 116. These components are accommodated in housing 102 with suitable control and/or regulating valves 110, 118. A first part of the drawn in air is passed over evaporator 108 and then divided into an air flow which flows directly into mixing chamber 350 (cold path 112) and into an air flow, which leads via heater 116 also to mixing chamber 350 (heat path 114). Any temperature between cold and warm can be set by varying the air volume in these two flow paths. This corresponds to air-side regulation. In another case, which is not shown, all air also flows through heater 116 and the output of heater 116 is controlled. [This occurs], for example, by varying the amount of water through heater 116, in the case of an electrical heating element via the regulation of the supplied power, and with the use of a heat pump system via regulation of the compressor speed and/or the stroke volume. This corresponds to water-side regulation.

Conventional sensors or signals to control the climate control device are a temperature setpoint, which can be set via a user specification, and an interior temperature and an air temperature downstream of the evaporator. In part, still other sensors or signals are available or used for the climate regulation. This can concern the outside temperature, outside humidity, cooling water temperature, the temperature in the mixing chamber of the climate control device and/or at one or more outlets, and the interior window pane temperature or a condensation sensor.

Depending on the interior temperature, the air temperature downstream of the evaporator, the temperature setpoint specification on the control panel, and optionally other sensor signals, the control unit calculates a setpoint ventilation air temperature for the climate control device and a setpoint air volume or blower control. This results in a setpoint energy input in the cabin.

If this setpoint ventilation air temperature is above the interior temperature, this is referred to as the heating mode and if below the interior temperature, as the cooling mode. Typically, the interior temperature in the vehicle cabin during controlled operation is between 20° C. and 25° C., depending on the user's temperature setting.

As shown in FIG. 3, in the climate control device itself an improved, energy-efficient temperature regulation or moisture regulation in the interior is realized by bypass 352 at evaporator 108. Unconditioned outside air can flow via said bypass 352 into the mixing area or mixing chamber 350 of the climate control device. Bypass 352 itself is equipped with a suitable regulating element for regulating the bypass air volume.

In the case of evaporator ventilation air temperatures of 10° C., typically outside temperatures >10° C. predominate (cooling mode). This means that the outside air is warmer than the air downstream of evaporator 108. If outside air, which flows via bypass 352, is now mixed with the air downstream of evaporator 108, depending on the temperature and volume of the outside air the desired higher air temperature (setpoint ventilation air temperature) results in the climate control device and at the outlets from the climate control device, without power needing to be supplied to heating element 116. Thereby, the (energy) efficiency of the climate control device can be increased.

Further, in addition moisture is introduced into the interior via the outside air guided over bypass 352, because this air is not dehumidified in evaporator 108. This additional moisture introduction can be used, at least to a limited extent, to control the humidity in the vehicle interior in that moister outside air is combined with the drier air downstream of evaporator 108. Thus, the relative humidity in the interior can be kept at a comfortable level and thereby improve the comfort of the occupants.

On the regulation side, a temperature sensor, which measures the temperature of the bypass air, is used upstream of evaporator 108 or in bypass 352. If moisture control is also to be carried out, a moisture sensor is used in addition upstream of evaporator 108 or in bypass 352. These signals are supplied to the control unit which determines from these the control variable for the regulating element in bypass 352.

Bypass 352 in the climate control device can be made expediently integrated in housing 102 above, below, and/or to the side of evaporator 108. However, one or more additional bypass channels are also conceivable. In air-side concepts, bypass 352 should end preferably in cold path 112 or in heat path 114 downstream of heater 116, and in water-side concepts in the flow path downstream of heater 116.

FIG. 4 shows a schematic illustration of a control panel 250, according to an exemplary embodiment of the present invention. Control panel 250 can be used to regulate or control a climate control system, as is shown, for example, in FIG. 2, or a climate control device, as is shown, for example, in FIG. 3.

Control panel 250 has a plurality of interfaces over which information or signals can be received or output. A temperature setpoint 460 can be received via a first interface. Temperature setpoint 460 can be fixedly predetermined or be variable. Temperature setpoint 460 can be input by a user into control panel 250 or be received from a suitable input device. Control panel 250 can be connected via one or more additional interfaces to sensors or measuring devices, which provide, for example, information on an interior temperature 462, a temperature 464 downstream of the evaporator, an outside temperature 466, an outside humidity 468, a cooling water temperature 470, or a mixing chamber temperature 472. Control panel 250 is designed to determine control variables for the climate control device based on the received information 460, 462, 464, 466, 468, 470, 472 and to output these as control information. Thus, control panel 250 can be connected via one or more additional interfaces to suitable adjustment or regulating devices, by which an air volume to be provided by the climate control device, air temperature, and depending on the embodiment air humidity as well can be adjusted. According to this exemplary embodiment, the control panel is designed to determine and to output information on a target position 474 of the temperature mixing valve, a target position 476 of the outlet valve, a compressor stroke 478, and blower control 480.

The described exemplary embodiments have been selected only by way of example and can be combined with one another. Although the exemplary embodiments are described with reference to a vehicle, the approach of the invention can also be provided for other possible applications.

The invention being thus described, it will be obvious that the same may be varied in many ways. Such variations are not to be regarded as a departure from the spirit and scope of the invention, and all such modifications as would be obvious to one skilled in the art are to be included within the scope of the following claims.

What is claimed is:

1. A temperature control device for a vehicle, the device comprising:
a first air duct configured to guide a first portion of an air flow;
a cooling device disposed in the first air duct and configured to cool the first portion of the air flow;
a second air duct configured to guide a second portion of the air flow; and
a mixing device configured to mix the first air flow from the first air duct with the second portion of the air flow from the second air duct in order to generate a temperature-controlled air flow.

2. The temperature control device according to claim 1, wherein the second air duct guides the second portion of the air flow past the cooling device to the mixing device.

3. The temperature control device according to claim 1, wherein the mixing device is configured as an air channel section, which has a supply opening for supplying the first portion of the air flow, a supply opening for supplying the second portion of the air flow, and a discharge opening for discharging the temperature-controlled air flow.

4. The temperature control device according to claim 1, having a heating device, which is disposed in a flow direction of the first portion of the air flow downstream of the cooling device, and which is configured to heat at least one part of the first portion of the air flow.

5. The temperature control device according to claim 4, wherein the heating device is configured to heat at least one part of the second portion of the air flow.

6. The temperature control device according to claim 1, further comprising a housing, which has at least one inlet opening for letting in the air flow and at least one outlet opening for letting out the temperature-controlled air flow, whereby the first air duct, the second air duct, and the mixing device are disposed within the housing.

7. The temperature control device according to claim 1, further comprising a regulating device that is configured to regulate a proportion of portions of the air flows relative to one another and/or a cooling performance of the cooling device.

8. The temperature control device according to claim 7, further comprising a measuring device for measuring air flow temperature and/or humidity, and wherein the regulating device regulates the proportion and/or the cooling performance depending on the temperature and/or humidity.

9. The temperature control device according to claim 1, further comprising a control unit configured to determine control information for controlling the temperature control device, based on information on air flow temperature and/or humidity, information on temperature and/or humidity of the temperature-controlled air flow and/or of an interior of the vehicle, and a setpoint temperature and/or setpoint humidity of the temperature-controlled air flow and/or of the interior.

10. A method for generating a temperature-controlled air flow for a vehicle, the method comprising:
guiding a first portion of an air flow via a first air duct;
cooling the first portion of the air flow;
guiding a second portion of the air flow via a second air duct; and
mixing the first portion of the air flow from the first air duct with the second portion of the air flow from the second air duct in order to generate the temperature-controlled air flow.
